(19) United States
(12) Patent Application Publication
(10) Pub. No.: US 2002/0120563 A1
(43) Pub. Date: Aug. 29, 2002

(54) System and method for effecting anonymous payments

(76) Inventors: William J. McWilliam, North Vancouver (CA); Jonathan Arn Rubenstein, Vancouver (CA); Jerry Sumpton, Delta (CA)

Correspondence Address: PEARNE & GORDON LLP, 526 SUPERIOR AVENUE EAST, SUITE 1200, CLEVELAND, OH, 44114-1484, US

(21) Appl. No.: 09/949,504

(22) Filed: Sep. 7, 2001

(30) Foreign Application Priority Data
Sep. 19, 2000 (CA) 2,320,514

(51) Int. Cl. G06F 17/60

(52) U.S. Cl. 705/39

(57) ABSTRACT

A method and system for effecting anonymous payments is disclosed wherein the method comprises the steps of receiving an order for a purchasing card from a customer, and assigning a purchasing card to the customer. The customer is able to use the purchasing card to purchase items online and/or offline.

### FIELD OF THE INVENTION

The invention relates generally to commercial transactions between parties including online transactions, and more particularly to a system and method of effecting payments in such transactions.

### BACKGROUND OF THE INVENTION

There has been explosive growth in the use of credit cards and debit cards in commercial transactions. There has also been explosive growth in the popularity and importance of electronic commerce and in the use of credit cards and debit cards online. This has led to a corresponding growth in fraudulent transactions including card theft, card cloning and misappropriation of credit information and bank account numbers. The overall growth of the Internet is mirrored by the e-commerce market. Wharton Research, January 2000 predicts that consumer online spending in North America will reach $133 billion within four years. Reasons for this staggering growth rate is due to the rapid increase in access to the Internet, good marketing, and the relative convenience of shopping online. Fraud in electronic commerce is more difficult to prevent.

Secondly as the number of online purchasers and the number of purchases increase, so too does the information trail regarding these transactions. Since the transaction instrument for most online purchases is a credit card, purchasers of products on the Internet are usually required to provide the vendor with personal information (often far beyond merely his name and address) and generally his credit card number and expiry date. Purchase and demographic information are gathered by vendors, by ecommerce enablers and by other interested parties. Often the party gathering this information utilizes or sells the collected information. A demographic profile of the customer, including the types of purchases that he makes and the types ofwebsites that he visits has a value to many companies, particularly those wishing to direct advertising to the customer.

Not only do databases gather personal information provided by purchasers who fill out online purchase forms, they also gather information related to the purchaser's credit card transactions.

In a study undertaken by Ernst & Young, 97% of potential customers who did not purchase online were uncomfortable sending credit card information over the Internet. The user may be uncomfortable for a number of reasons. He may not trust the Internet vendor to limit the use of the credit card to the intended transactions. Or, he simply may want to make his purchase anonymously, not unlike making a cash purchase at a grocery store.

While many purchasers are unconcerned with providing personal and credit card information, particularly to major vendors, there is a significant segment of the population that is hesitant to supply such information. These users are not only concerned that their credit card may be used fraudulently; they are also concerned that others may know what they have purchased with their credit card, and from whom. This hesitancy maybe based upon a concern regarding the use of such information. It maybe because the user does not want to be placed on an Internet mailing list. Or, in a growing number of cases, it may simply be because the purchaser wants to maintain his privacy.

Whether for reasons of maintaining anonymity, reluctance to provide information that is thought to be extraneous, or simply because of the time involved in filling out a form, some Internet purchasers are hesitant to provide this information. Some are reluctant to use their credit cards on the Internet, particularly in dealing with unknown merchants, because they are not comfortable with what will become of their history of purchases.

Beyond privacy concerns, Internet sales are sometimes lost because the merchant can not afford to accept a credit card for a purchase value that is less than some minimum amount dictated by the credit card company.

A number of payment systems and controls within those systems have been developed, such as travellers' cheques, signatures on cards, authorization systems, personal information inclusions on physical cards, and expiry dates. However, a system of precise control over card use does not exist. Reflecting the need for confidentiality, a number of companies have been established to provide Internet users with identity-management services. For example, companies exist that provide customers with the ability to browse the web without revealing their identity. Other companies provide an identity manager that allows the user to control what bits of personal information are shared or sold to marketers. Other companies offer services that allow the use of anonymous email or anonymous chat room discussions.

For users wishing to avoid filling in forms, a number of these identity management systems are available in which the customer needs only to fill in one form.

A form filler company then provides the customer with a service that automatically fills in any future forms related to purchases made on the Internet. In general, the information provided by the customer to the form filler company need not be an accurate depiction of the customer other than the information related to his credit card.

Identity management of form filler companies address only part of this problem.

They do not address the concern of the user wanting to make a purchase online using his credit card because to make such a purchase the credit card number (and consequently the identity of the user) must be divulged.

While the credit card is still the simplest transaction instrument for effecting payments online, there are a number of other methods available to pay for products purchased on the Internet. These include digital checking accounts whereby electronic checks are sent over the Internet and cleared online. This latter method includes smart cards and stored value cards. While these methods can facilitate micro cash purchases and need not utilize the customer's credit card on-line, they are not designed to protect the user's identity or his purchase history.

Another method of making online purchases without using a credit card is by using some form of digital cash. Companies may provide a digital cash service that allows the user to maintain the same anonymity as with real cash. These services also allow the user to make small purchases without the merchant being charged with a minimum transaction cost. The drawback of these digital cash services is that they require the cooperation of the merchant. A purchase cannot be made with a merchant that does not subscribe to the service.

For those not having a credit card or not wishing to make a credit card purchase, there are services available which will allow the purchaser to be billed through an Internet Service Provider or through the user's telephone company. These purchases, however, are not anonymous and require the cooperation of the merchant or subscription to an outside payment agency.

For a customer wanting to maintain anonymity for his financial transactions, a number of companies provide offshore credit cards. This service, however, is generally only available to customers willing to maintain significant cash balances with the issuing institution. The set up and maintenance costs of such accounts can also be very expensive.

A customer wishing to maintain Internet and purchase anonymity while maintaining the easy use of a credit card currently has to establish a relationship with several companies and interface those services in a somewhat complicated and expensive manner.

One way a user can completely maintain his anonymity in making a purchase is to use an anonymous web browser services and to also utilize an offshore credit card that does not relate to this true identity. Such credit cards are available from a number of offshore financial institutions but they are expensive both for the original set up and for the sizeable cash balance required from the issuer. This is a time consuming and cumbersome process. The offshore credit card remains vulnerable to abuse.

Financial institutions and merchants also would benefit from increased security because they often take the credit risk of fraudulent credit card use and can reduce the significant costs they incur in preventing, detecting and recovering abused credit. There is also risk associated with offline purchases, namely the risk of fraud and credit theft. These risks exists to both the transaction instrument holder and the issuing financial institution. Currently, there are minimal restrictions available to personal transaction instrument holders for modification to the transaction instrument other than credit limit and cancelling the transaction instrument. These restrictions, however, are in most cases set by the issuing financial institution.

Currently transaction instruments issued to corporations, such as “corporate purchasing cards”, are available for modification of restrictions including:

credit limit;

dollar amount per day, month, billing cycle or transaction;

number of transactions per day, month, or billing cycle;

non-renewing credit;

supplier type and merchant industry restrictions; and

limits by employee.

However corporate purchasing cards are not widely available to the general public and also do not allow each user control over their restrictions.

Accordingly there is a need for a way to provide a simple payment system that enables customers to securely conduct physical payment transactions without exposing their credit card information to fraud. Also, there is a need for a way to provide simple online payment service that enables customers to anonymously and securely conduct online payment transactions and particularly to effect payments online.

### SUMMARY

Broadly stated, embodiments of the invention are payment systems that addresses the aforementioned problems. In one embodiment, the payment systems use physical and virtual payment cards which are controlled according to specific parameters that can be preset or dynamically determined.

A focus of a preferred embodiment of the current invention is to provide Internet users an anonymous, secure and universally accepted payment method. The online payment service of the current invention will allow a customer 11 to buy and shop anonymously at any merchant 12 site online or otherwise. Anonymity of the payment service may be achieved by rotating a large number of credit card Purchasing Cards that the OPS 33 possesses in its assigned inventory of credit card numbers. Every time a customer 11 places an order with the OPS 33 or Fl for an online transaction, the OPS 33 or FI may randomly assign one or multiple card numbers available in its inventory for customer use. The use of these card numbers may be restricted by a limited number of transactions, a certain period of time, and/or a credit limit, all of which may be determined by the customer 11. The customer 11 may also instruct the OPS 33 or FI to deliver physical cards for use by the customer 11 for the purchase of goods and services from physical merchant locations. The OPS 33 may authorize a customer 11 to make online purchases as corporate members, thereby eliminating the need for its customers to give out their own personal information when making purchases at other online merchant sites. As no customer 11 is associated with any specific Purchasing Card, purchases issued to the OPS 33, customers are as anonymous as possible.

The payment service is also secure. In one embodiment the OPS 33 takes the responsibility for any online theft or fraud that may occur on its corporate Purchasing Cards. Therefore, a customer 11 may use the Purchasing Card to conduct purchases over the Internet without concern that their own credit card information could be stolen. Furthermore, the OPS 33 may constantly change the parameters of its corporate Purchasing Cards such as credit limit, expiry date, cardholder address and cardholder name, in order to reduce the chances of fraud. Finally, the OPS 33 may store its customer information at different offshore locations and/or on different servers to protect the integrity and privacy of all private information about a customer 11, both online and offline.

According to an embodiment of the invention, there is provided a method of effecting anonymous payments. The method comprises the steps of receiving an order for a purchasing card from a customer, and assigning a purchasing card to the customer. The customer is able to use the purchasing card to purchase items online and/or offline.

According to another embodiment of the invention, there is provided a method of effecting online payments. The method comprises the steps of an end user obtaining a purchasing card, and an end user shopping online using the purchasing card information to effect payment.

According to another embodiment of the invention, there is provided a system for effecting online payments. The system comprises a customer network, a merchant network, and an online payment service network. The customer network is in communication with the merchant network, and the online payment service network is in communication with the customer network for creating a credit identity for a customer.

According to another embodiment of the invention, there is provided an online payment service for effecting online payments. The online payment service comprises a receiver for receiving an order for a purchasing card from a customer, processing means for securing payment from the customer for the order, and a notifier for notifying the customer of purchase card information.

According to another embodiment of the invention, there is provided a method of effecting a payment. The method comprises steps of obtaining a transaction instrument, assigning restrictions to the transaction instrument, and a customer using the transaction instrument to make purchases.

According to another embodiment of the invention, there is provided computer-readable media for storing instructions or statements for use in the execution in a computer of a method for effecting an online payment. The method comprises steps of receiving an order for a purchasing card from a customer, and assigning a purchasing card to the customer. The customer is able to use the purchasing card to purchase items online.

According to another embodiment of the invention, there is provided a computer program product for use in the execution in a computer for effecting an online payment. The method comprises steps of: receiving an order for a purchasing card from a customer, and assigning a purchasing card to the customer. The customer is able to use the purchasing card to purchase items online.

According to another embodiment of the invention, there is provided a computer data signal embodied in a carrier wave and representing sequences of instructions which, when executed by a processor, cause the processor to effect an online payment. The sequences of instructions comprises the steps of receiving an order for a purchasing card from a customer, and assigning a purchasing card to the customer. The customer is able to use the purchasing card to purchase items online.

Advantages of embodiments of the current invention include the following:

Reduction in fraudulent transactions;

Controlling use of cards and other payment transactions;

Customers can conduct transactions with complete anonymity without the need to partner with vendors or implement or modify existing software;

The service blends with using the credit card for processing e-commerce transactions;

The credit card service can be combined with a complete range of additional privacy services;

It can be used anywhere on the Internet;

It does not require cooperation of online merchants;

It utilizes existing credit vehicles;

Transactions conducted using the profiled transaction instrument will reduce the risk of credit theft to the issuing financial institution, the merchant and the transaction instrument holder; and

The profiled transaction instrument may be used for both online and offline purchases.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

Embodiments of the invention will be described with reference to the accompanying drawings, wherein:

FIG. 1 illustrates the current system used for effecting payment for online purchases;

FIG. 2 is a flow chart of a method of effecting payment for online purchases in an embodiment of the invention;

FIG. 3 illustrates the system used for effecting payment for online purchases in an embodiment of the invention;

FIG. 4 is a flow chart of a method of effecting payment for online purchases in an embodiment of the invention;

FIG. 5 illustrates system components of an OPS server;

FIG. 6 illustrates the user management component of the OPS server in greater detail; and

FIG. 7 illustrates another embodiment of the invention.

Similar references are used in different figures to denote similar components.

### DETAILED DESCRIPTION

A private payment Internet service that provides a firewall between the customer and the merchant during an Internet purchase is described. In one example, the private payment service is an online payment service (OPS). The customer utilizes his or her own credit card but the merchant does not see that credit card or related information. Not only is the customer anonymous to the merchant, but also the customer's credit card bill will not show from what merchant a product or service has been purchased. Features of the present invention include the following:

The merchant does not know the true identity of the customer as the merchant is dealing with the customer's nominee who is either an OPS 33 or FI;

The merchant does not identify the customer, his financial institution account or credit card;

The customer's conventional credit card bill does not reflect what purchases were made or from whom those purchases were made.

Only a transaction charge from the OPS is shown;

The OPS does not determine what purchase the customer has made;

only that he has utilized the OPS credit card for a particular dollar amount, time period or a specific transaction with a merchant;

The customer is not required to fill out the merchant's information form. This function is provided by the OPS via a form filler service;

The OPS preferably does not utilize cookies so there is no way for a merchant to acquire customer information;

The merchant does not send advertisements or other unsolicited materials to the customer; and

The credit card may be enabled to authorize payment only to certain specified or predetermined merchants.

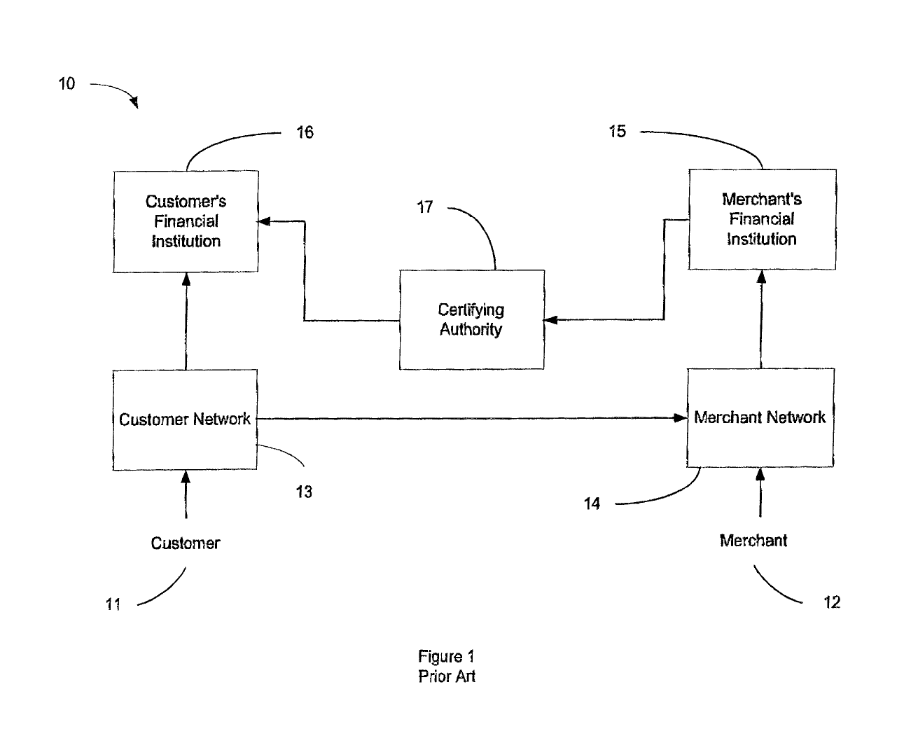

FIG. 1 illustrates a current system 10 of making online purchases. A customer 11 communicates with a merchant 12 via a customer network 13 and a merchant network 14. The merchant network 14 communicates with a certifying authority 17 through the merchant's financial institution 15 to verify the customer's 11 authentication. Authentication is any process by which the customer 11 establishes his identity in order to effect payment. In order for proper authentication to be established, the customer 11 provides personal identification information (e.g., a password, etc.). The merchant 12 also is able to communicate with the customer's financial institution 16 through the merchant's financial institution 15 and the certifying authority 20 to verify the customer's 11 authentication.

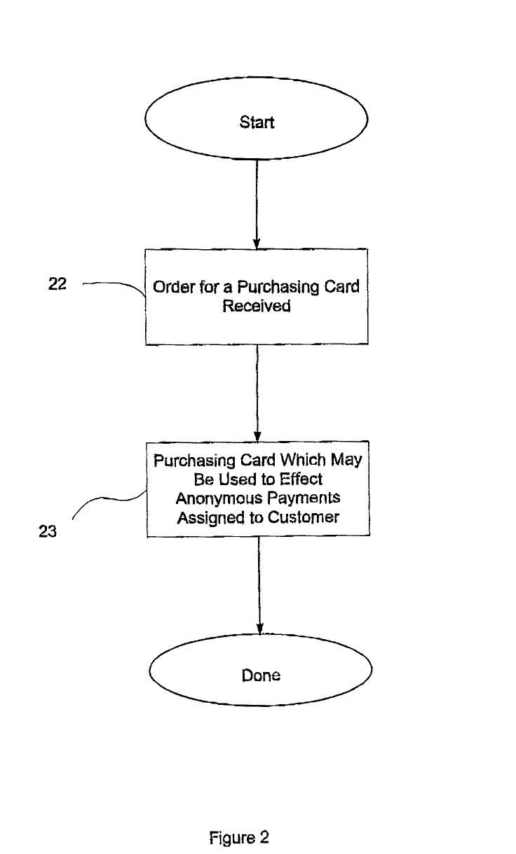

A methodology which addresses objects outlined above, is presented as a flow chart in FIG. 2. This figure presents a method of effecting online payments which is initiated when an order for a purchase card is received 22. The purchase card may be a virtual credit card or virtual debit card. The purchase card is assigned to a customer 23. This purchase card contains information which may, in one embodiment of the present invention, be used in the place of credit card information for online purchases.

The invention of FIG. 2 addresses some problems in the prior art. Customers may be able to shop online using a virtual credit card which a merchant would not associate with the customer. However, the merchant would receive valid funds from the purchase card.

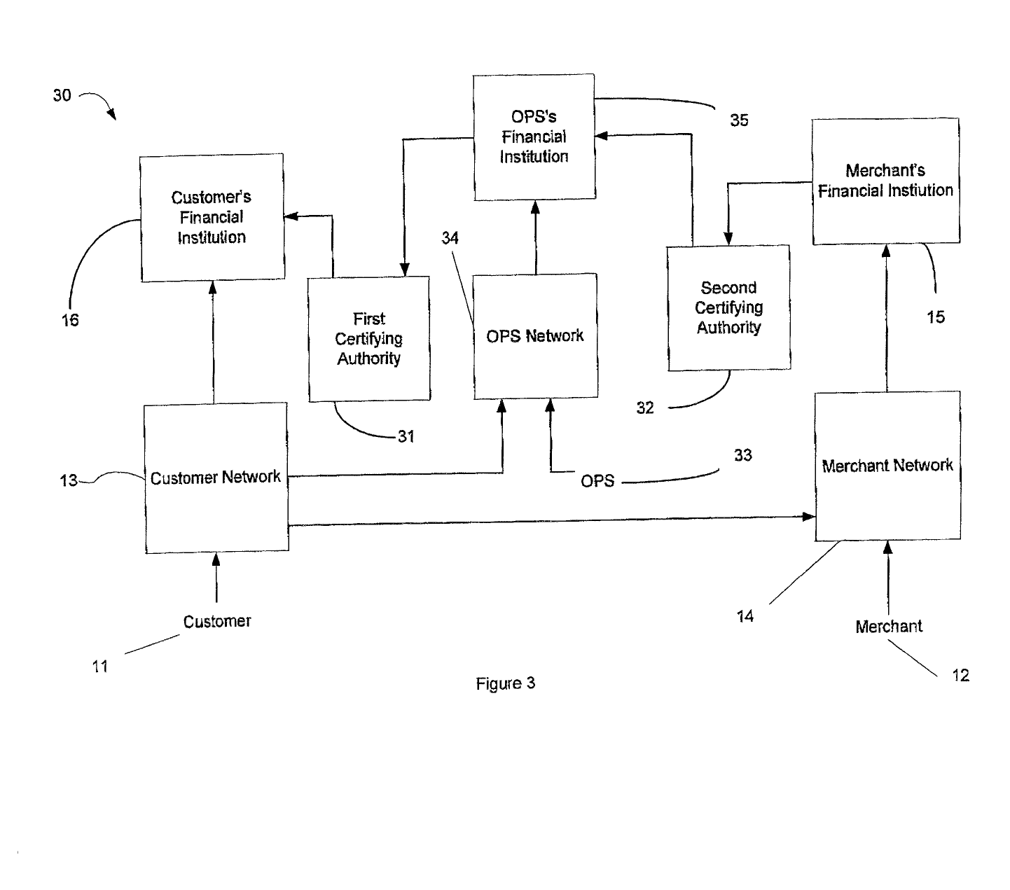

FIG. 3 illustrates the system of effecting a payment online 30 in conjunction with the teachings of an embodiment of the present invention. A customer 11 communicates with a merchant 12 via a customer network 13 and a merchant network 14. The customer 11 may also communicate with an OPS 33. The customer 11 may initiate contact with the OPS 33 via the customer's financial institution 16, but may also contact the OPS 33 through the OPS network 34.

The customer 11 may shop at a merchant 12 website, and may provide payment at the merchant 12 web site. However, the merchant 12 and the merchant network 14 do not authenticate nor communicate with the customer's financial institution 16. The OPS 33 authenticates the customer 11 in order to effect the online payment. This process will be described below. From the merchant 12 vantage point, the customer 11 is the OPS 33. Thus, the merchant 12 does not know the identity of the actual customer 11.

The credit card number the merchant 12 receives provided by the customer 11) may come from any credit card issuer that has issued a credit card number to the OPS 33 and subsequently assigned to the customer 11. The credit card account authenticated by the merchant 12 is an OPS 33 account. In this embodiment, cards are not physically issued to a customer 11. In this way, the OPS 33 creates a credit identity that exists for only the length of time needed to effect the online payment transaction. The card numbers may be issued dynamically, in real time.

The credit cards supplied to a customer 11 are “Purchasing Cards”. These Purchasing Cards may be regulated by the issuing financial institution (FI), i.e., the OPS financial institution 35, as discussed below. It is possible for the customer financial institution 16 and the OPS financial institution 35 to be the same financial institution. Similarly, the merchant financial institution 15 may be the same. Issuing financial institution (FI) will refer to the financial institution which is issuing the Purchasing Card to the customer 11.

A Purchasing Card assigned to a customer can be used by the customer to purchase anything online. Purchasing Cards may come in various types. In an example of an embodiment of the present invention, the FI offers four types of payment for its service. The first are Type I Cards. These are prepaid by the customer via a variety of methods as is detailed below. These cards have a credit limit not exceeding the prepaid amount and are valid for a single transaction only.

The second are Type II Cards. These are preauthorised (i.e., by the customer's 11 credit card issuer) but no payment is made until a purchase is made. These have a credit limit determined by the customer 11 and are valid for a single transaction only.

The third are Type III Cards. These are pre-approved wherein the customer 11 is invoiced at the end of each month. These have a predetermined credit limit and are valid for any number of transactions. These cards include an expiry date. In general, they are available to VIP customers.

The fourth are Type IV Cards. These can be Internet address enabled which may allow a customer 11 to purchase products from certain designated merchants 12.

In general, a customer 11 begins with a Type I card. Over time, as a relationship is formed between the customer 11 and the FI, the customer 11 maybe allowed access to Type II, Type III and Type IV cards. While a customer 11 may be issued a credit card number and a PIN number, no card is physically issued to the customer.

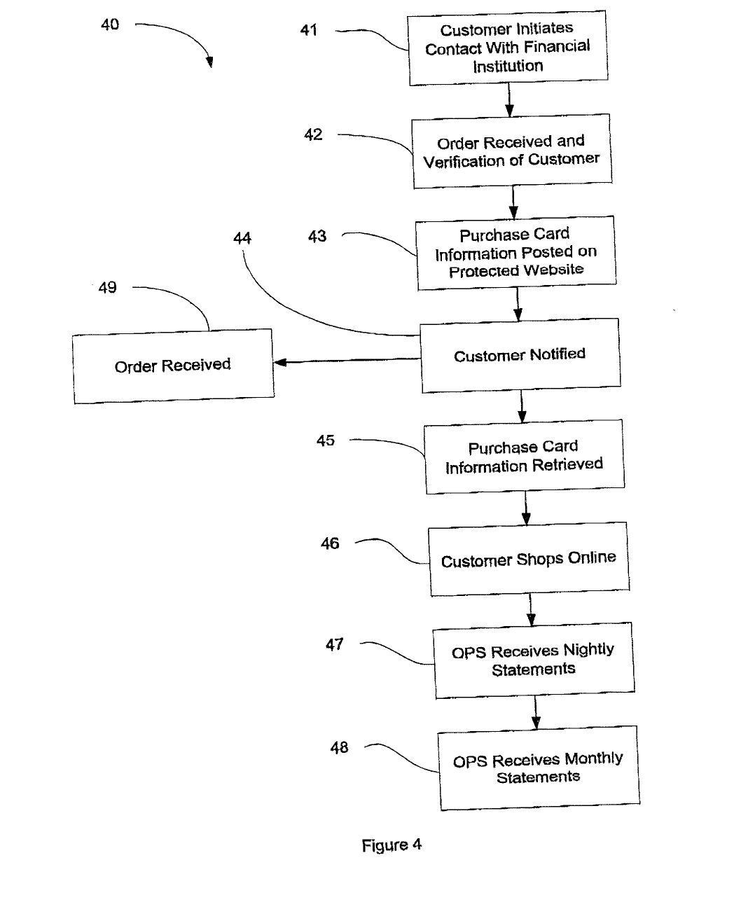

FIG. 4 shows the steps in an OPS transaction process 40 as implemented in one example of an embodiment of the present invention. In the first step 41, a customer 11 may initiate contact with the customer financial institution 16. As stated previously, in an alternative embodiment, the customer 11 may initiate contact with the OPS 33 via the OPS network 34. The customer 11 enters order information and authorizes payment (to the OPS 33) on an online order form such as a secure sockets layer (SSL) secured online order form. The customer 11 requests the use of a credit card that is issued to the OPS 33.

In the second step 42, the order is processed by the FI. The FI the credit availability of the customer 11. If the customer 11 is already known to the FI, then there may be a customer profile available to the FI. If not, then the information collected on the online form in step one 41 will include the information needed by the FI to perform this second step 42. If the customer 11 does not have the credit to obtain a Purchasing Card, then the customer 11 may reapply for a lesser amount. Once the customer's credit availability is determined to exist and payment information is received, the transaction is processed and authorization is received for payment from the OPS financial institution 35. Again, the OPS financial institution35 and the FI may be the same financial institution.

This order process may:

(i) authenticate and capture payment (in the case of Type I Cards) or preauthorisation (in the case of Type II Cards) from the customer's 11 credit card company; and

(ii) create a temporary credit identity by assigning an appropriate Purchase Card for the customer 11, taking a Card from its inventory of available Cards.

The OPS 33 may offer a customer 11 a number of payment options for obtaining the use of a Purchasing Card. Payment may occur via one or a combination of, the following: filling out an online form utilizing the Internet, or contacting the OPS 33 directly either by telephone, fax, mail, or email. Payment may come from the customer's bank account or from a customer credit card.

In the third step 43, the temporary credit identity may be created and the OPS 33 may post the assigned Purchasing Card number onto a password protected website area upon approval of the transaction.

In the fourth step 44, the OPS 33 may notify the customer 11 that their request for use of a Purchasing Card has either been approved or declined via email. The response is dependent upon the authorization response received from the Fl. If the customer 11 has been approved, the customer service operator may send an electronic mail message to the customer 11 to notify him or her where and how to collect the electronic credit card. The designated uniform resource locator (URL) and a unique username/password from Step 3 (valid only within a certain time period) may also be attached within the electronic mail message.

If the customer 11 does not have the credit to obtain a Purchasing Card, then the customer 11 may reapply for a lesser amount. Another option if the customer 11 has been declined, if for the customer 11 to provide an alternate method of payment before proceeding 49. Such alternative payment form may include a check, money order or any such form of payment.

In the fifth step 45, the customer 11 may retrieve the Purchasing Card details online by logging in and collecting the Purchasing Card they ordered from the designated URL. The website may contain the information for one or more Purchasing Card. The information provided on the site will enable the customer 11 to conduct one or more online transaction using the Purchasing Card(s).

For example, if a customer 11 purchased a $50 Purchasing Card, they would be directed to a web site listing: a total available credit limit of $50, a transaction limit of $50, the billing address associated with the Purchasing Card, and the name associated with the Purchasing Card. In this embodiment, the customer 11 may obtain the credit card information prior to shopping online (sixth step 36 below). In an alternative embodiment, the customer 11 may obtain the credit card information at the time of actually effecting the online payment.

In one embodiment of the present invention, the website contains the information for only one Purchasing Card such that the customer 11 may conduct only one online transaction using the Purchasing Card. The number of cards issued and their restrictions may be selected by the customer 11 on the online order from in the first step 41. Possible restrictions to Purchasing Cards will be described below.

In the sixth step 46, the customer 11 may proceed to shop online. The customer 11 locates the merchandise they require on any site accepting credit or debit card information as method of payment. On the merchant's 12 shopping form, the customer 11 uses the temporary credit identity information provided to them in Step 5.

The OPS 33 may also establish an online account for the customer 11 to track their balance, as is discussed below. If shipment of goods is required, the customer 11 may fill in the appropriate shipping instructions in the shipping information section of the merchant's 12 site.

After the payment, the following may be stated:

The merchant 12 does not know the real identity of the customer 11;

The FI does not know the product purchased;

The credit card number issued (the purchasing card) is unlikely to be stolen as it only exists on the Internet for a short period of time;

The credit card number issued (the purchasing card) is unlikely to be at risk to a credit card number generator as there is little chance of the number generator having the same amount or time period authorized by the customer 11;

The customer's bank statement shows an item debited to his or her financial institution 16; and

The merchant 12 cannot reuse the credit card number issued as it may only exists for the one purchase.

In the seventh step 47, the OPS 33 reconciliation process occurs. The OPS 33 receives online statements nightly from the FI listing all transactions processed on Purchasing Cards issued on the OPS 33 that day. In alternative situations, the FI and the OPS financial institution 35 may be the same entity or may be different entities. The OPS 33 deducts the amount spent on each Purchasing Card from the cardholder's (the customer 11) account. Any balance remaining in the customer 11 account is then credited toward another Purchasing Card or refunded back to them via their original method of payment.

For Type I and Type II cards that are valid only for a single transaction, any surplus in the customer's balance may be refunded, usually by the same method by which payment was made. For Type II cards, the surplus may just remain in the account for future use. If an expiry date is present, any surplus may be refunded on the expiry of the card.

In the eighth step 48, the OPS 33 payment issuer may receive monthly statements from its FI regarding the balances on the Purchasing Cards. Payment may be made to the FI and the Cards with zero remaining balance may be returned to the inventory to be reassigned to a new customer. Again, in alternative situations, the FI and OPS financial institution 35 may be the same entity or different entities.

As mentioned previously, the customer 11 may determine the credit limit, time constraints, and/or other restrictions to be placed on the Purchasing Card during the first step 41, subject to the FI's approval. Alternatively, the OPS 33 may regulate (specify the limits or range of limits to be placed on) each Purchasing Card by the Fl prior to the date they are issued to them. Once issued, the cards may be modified at anytime by the FI upon receipt of request from the customer 11 or OPS 33, subject to the FI's approval. The FI upholds the limits placed on the cards. Many cards may be contained in a database and issued to customers upon request. Alternatively, a customer 11 may also select from available, and predetermined, Purchasing Cards.

In one embodiment, the limiting criteria used on Purchasing Cards may include:

Limiting the number oftransactions that can be conducted on the card during a specified time period (such as one transaction per month/year/etc.);

Limiting the credit limit amount available to the cardholder (possibly variable from one dollar up to five thousand dollars); and/or

Limiting the transaction amount available to the cardholder (possibly variable from one dollar up to five thousand dollars).

In one embodiment, for online purchases, a virtual card can be controlled by specifying restrictive parameters (for example: single transaction, 30 minute duration, fixed amount or range). The virtual Purchasing Card can also be issued using a pseudonym to provide anonymity.

In an alternative embodiment, such purchasing cards may also be issued as physical cards that can be authorized for use in advance or dynamically. The difference between these physical cards and traditional credit cards is that there would be no identification information and no expiry date on the card. These items would be included in the information on the magnetic strip on the physical card. The credit limit and expiry date may also be on the magnetic strip and the owner of the card or the payee maybe the FI or its nominee. This will allow a customer 11 to purchase goods and services anonymously with a credit card, which acts like cash. The physical card may also minimizing a paper trail of payments by the customer 11, allowing for a degree of anonymity.

The physical card may be discarded when it expires. It may be returned in the sense that the number that it was assigned is now reusable by the FI once the card has expired or the credit limit has been used or both. The number the physical card is assigned may also be reused in the case that the physical card was lost or stolen.

A focus of a preferred embodiment of the current invention is to provide Internet users an anonymous, secure and universally accepted payment method. The online payment service of the current invention will allow a customer 11 to buy and shop anonymously at any merchant 12 site online or otherwise. Anonymity of the payment service may be achieved by rotating a large number of credit card Purchasing Cards that the OPS 33 possesses in its assigned inventory of credit card numbers. Every time a customer 11 places an order with the OPS 33 or FI for an online transaction, the OPS 33 or FI may randomly assign one or multiple card numbers available in its inventory for customer use. The use of these card numbers may be restricted by a limited number of transactions, a certain period of time, and/or a credit limit, all of which may be determined by the customer 11. The customer 11 may also instruct the OPS 33 or FI to deliver physical cards for use by the customer 11 for the purchase of goods and services from physical merchant locations. The OPS 33 may authorize a customer 11 to make online purchases as corporate members, thereby eliminating the need for its customers to give out their own personal information when making purchases at other online merchant sites. As no customer 11 is associated with any specific Purchasing Card, purchases issued to the OPS 33, customers are as anonymous as possible.

The risk due to loss of a Purchasing Card in this system may be upon the customer 11. If the customer 11 authorizes a number and receives a physical card and loses the card then the finder may purchase goods or services and may use the card. What the customer 11 may do is to notify the system of loss and the number may be cancelled in the system. The web interface contemplated in this embodiment may be able to cancel the number.

The loss may be the customers' if the finder, prior to notification to cancel by the customer 11, uses the card within the limits prescribed by the customer 11. The limits are unknown to the finder so the odds are against successful use by the finder, which may not be the case of current cards issued. The finder may try to buy an item worth more than the credit authorized for the card and be denied as the system will be set up to provide for credit limit authorization only at the time of issuance. The card has prescribed credit and expiry limits. These prescribed limits have nothing to do with the credit available, generally, to the client as may be the case if the customer lost his regularly issued traditional credit card. This feature may reduce the loss to the credit system generally.

If the customer has authorized the credit for a specific expiry date, the credit authorization may expire before the finder can use the card. The finder of a lost or stolen Purchasing Card contemplated in the embodiments of this invention may have no idea of what terms and conditions the customer 11 applied to the card. In addition, the system may be set up so that the use of the card could trigger its cancellation if the finder attempts to buy an item in excess of the Purchasing Card credit limit. In this scenario, the finder would not get a second chance at using the card for a smaller purchase.

The payment service is also secure. In one embodiment the OPS 33 takes the responsibility for any online theft or fraud that may occur on its corporate Purchasing Cards. Therefore, a customer 11 may use the Purchasing Card to conduct purchases over the Internet without concern that their own credit card information could be stolen. Furthermore, the OPS 33 may constantly change the parameters of its corporate Purchasing Cards such as credit limit, expiry date, cardholder address and cardholder name, in order to reduce the chances of fraud. Finally, the OPS 33 may store its customer information at different offshore locations and/or on different servers to protect the integrity and privacy of all private information about a customer 11, both online and offline.

As the payment service involves only simple credit card transactions, it does not require pre-integration with any online merchant system. A customer 11 may use the anonymous payment service anywhere on the Internet where credit cards are accepted.

In a further embodiment, in the case of a customer 11 who wishes to purchase physical goods on the Internet but further maintain his anonymity, arrangements can be made to have the goods delivered to a post office box or to any outfit allowing its address to be used as a delivery address, such as a courier office. In the latter case, the customer 11 may be issued an identification number. This number may also be provided to the merchant as a part of the shipping address.

In another embodiment of the invention, a customer 11 wishing to verify his online purchases made with a Purchasing Card may see the charges shown on his regular monthly credit card bill, or bank account updates, as purchases from the FI. There would be no indication regarding what purchases the OPS 33 made on the customer's behalf. In fact, because of the multiplicity of transactions, the merchant 12, customer 11, even the OPS 33 may not know what particular purchases were made by an individual customer. Alternatively, in a different embodiment of the present invention, the monthly proprietary credit card bill may include the OPS purchase details, if so desired.

A customer 11 may also be able to check his account on the Fl or OPS websites to determine the amount of his purchases during the month and the status of his account.

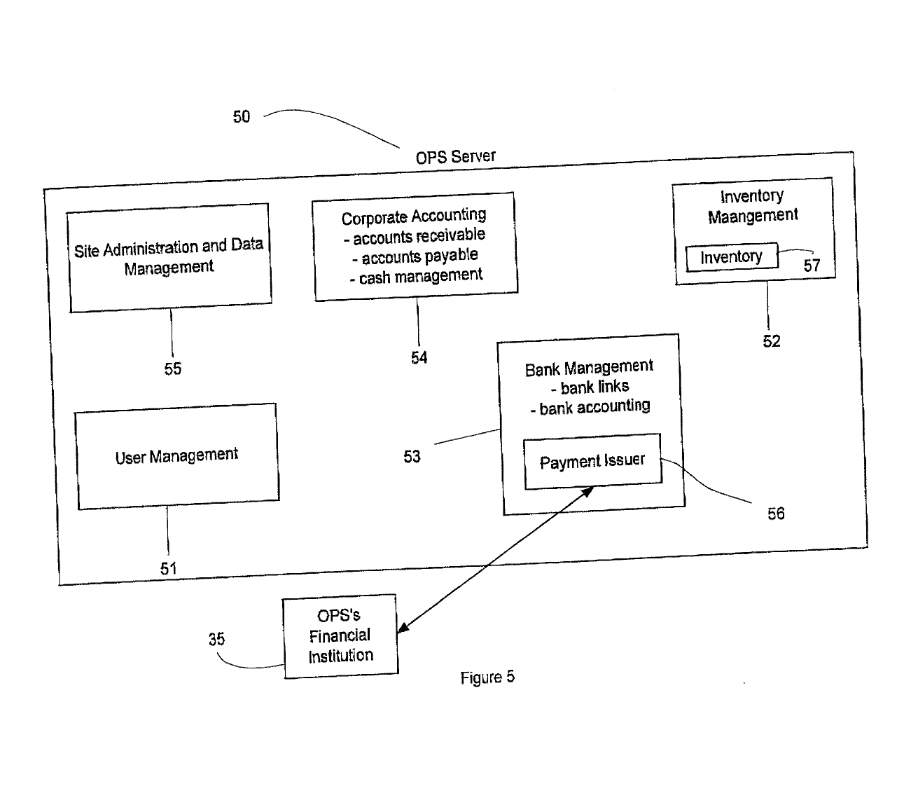

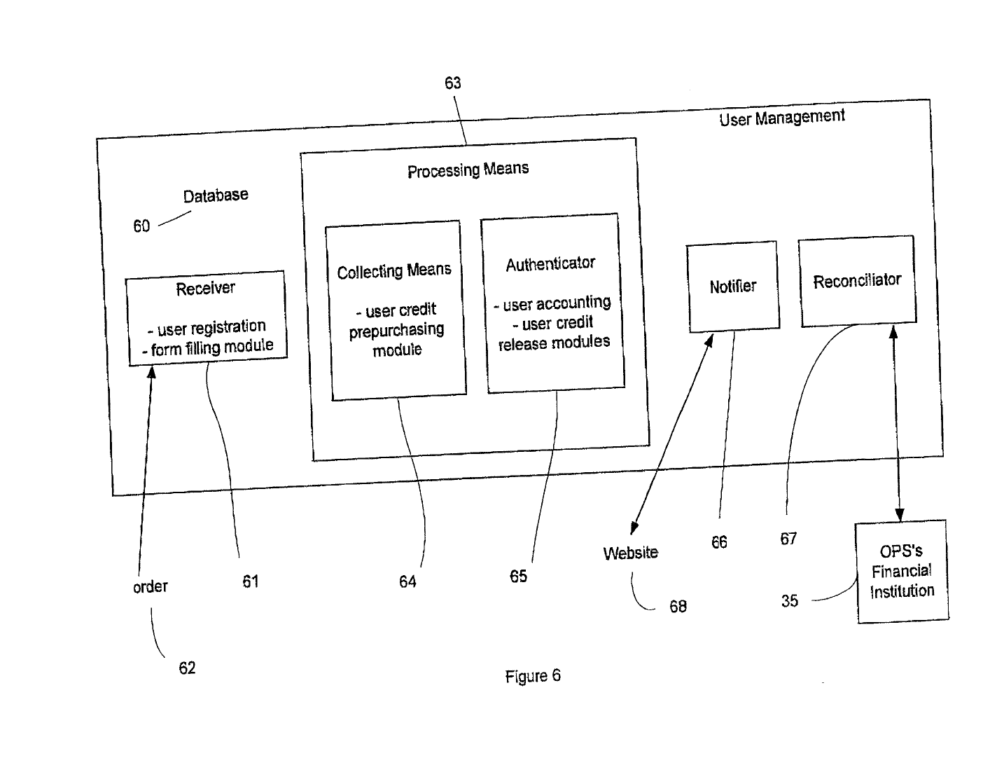

FIGS. 5 and 6 illustrate OPS network 34 in further detail. OPS network 34 includes OPS server 50 for facilitating transactions between OPS network 34, customer network 13 and a certifying authority. In one situation, the certifying authority is ht eFI if it has issued the traditional credit card. If not, the FI may query the system to verify the credit and collect payment before issuing the Purchasing Card. The FI may reduce its credit risk in this manner. The OPS server 50 may include the following system components: user management 51, inventory management 52, bank management 53, corporate accounting 54, and site administration and data management 55.

User management 51 may receive, processes and reconciliate customer orders. User management 51 may include a Receiver 61 and Processing means 63. Receiver 61 may be used for receiving the order 62. If the order 62 is placed via the Internet, then the order 62 may be received through a graphical user interface. The receiver 61 may include a user registration module and a form filling module. The customer information database 50 stores the received information.

Processing means 63 may include collecting means 64 and authenticator 65. Collecting means 54 may use a user credit pre-purchasing module for securing payment for use of a Purchasing Card. Authenticator 65 may use a user credit release module for authenticating the customer.

A Purchasing Card may then be assigned to the customer from Inventory Management 54, which includes inventory 57 of Purchasing Cards.

User management 51 may further include notifier 66 and user reconciliator 67. Notifier 66 may inform the customer 11 of an approval (or decline). If the customer 11 is approved, notifier may also provide access information to website 68 containing the Purchasing Card information. Reconciliator 67 may receive daily statements of transactions made with various Purchasing Cards. Reconciliator 67 then may accordingly adjusts each customer's balance.

Bank Management 53 may include various links to financial institutions and conduct the bank (or financial institution) accounting. Payment issuer 56 may receive monthly statements from the Fl regarding money owed on each Purchasing Card. Payment issuer 56 issues the payments and returns the Purchasing Cards to inventory 57 for reassignment to a new customer.

Reconciliator 67 may receive daily statements of transactions made with Purchasing Cards. Reconciliator 67 then may accordingly adjusts each customer's balance.

Payment issuer 56 may receive monthly statements from the Fl regarding money owed on each Purchasing Card. Payment issuer 56 may issue the payments and return the Purchasing Cards to inventory 57 for reassignment to a new customer.

Corporate accounting 54 may include accounts receivable, accounts payable and cash management modules for the OPS 33. Site administration and data management 55 may include means to manage the infrastructure of the OPS 33. Both of these are standard for any business and are not further discussed in this document. In one embodiment, the customer's financial institution 16 may only receive one end of each transaction. That is, each transaction will have a different issuer and customer financial institution 16. In an alternative embodiment, the customer's financial institution may receive both ends of a transaction.

Fraud is also a problem to Internet vendors. While some credit card companies claim that fraudulent use of its cards is less than 0.1%, the company CyberSource (CYBS) commissioned a study that indicated that 5-25% of online credit card sales are fraudulent. One of the reasons for this discrepancy may be that some credit card companies are seldom the victim of online fraud since they are liable only if the merchant has obtained a customer signature; an unlikely occurrence for an online purchase. Consequently, the merchant is liable for all other fraudulent purchases online.

In one embodiment, the OPS system contemplates a fee for service relationship between an Fl and a customer. The FI and the customer 11 may also enter into a relationship where signatures are provided before the customer 11 uses the OPS system. This relationship may assure the merchant 12 of payment by way of the OPS system.

Due to the risk of fraud, a combination of firewalls, cryptography and safety nets may be established by an FI or OPS 33 in order to protect themselves against:

double spending (spending the same money twice);

the use of fraudulent credit cards (cards which have not been legitimately issued); and/or

the use of stolen credit cards.

One such example of a safety net is a system wherein the inventory of cards comprises of cards that are issued to customers, returned to the inventory upon expiry and reissued only when all other cards have been issued. That is, each card is used once in sequence until a card is reissued. Also, the cards could have balances that decline with each subsequent issue and validation dates that change with each issue. For example, a card issued to Customer A may have a limit of $200, but when it is issued to Customer B, it will only have a balance of $100.

Through its membership requirements, there is also protection against the customer who denies making a purchase. For instance, the IP address could be used to track the customer.

Since merchants who wish to remain in business are seldom the source of fraud, the merchant related risk is low. However, a risk for the customer 11 may be paying for a good or service and the merchant 12 not supplying the good or service. Certain protocols may be established to protect against phony merchants. These protocols may include, among others, the denial of service to merchants in particular countries and merchants who offer certain types of products which attract a higher percentage of fraudulent credit card purchases. The protocols may also include the denial of service to merchants who have denied delivery of validly purchased goods. In such a situation, the merchant IP addresses may be identified and added to a listing of offending sites to be used to alert customers. Another protocol may include a restriction that the OPS 33 does not conduct dealings in cash nor in individual transactions exceeding $5000 (or another suitable amount), in order to limit the chance of anyone using the OPS 33 for the purpose of laundering money.

In one embodiment, the OPS 33 may operate as an anonymous prepaid credit card payment service operating in US funds. However, the service may operate in any desirable currency.

In another embodiment, in addition to the anonymous payment service described above, there is also provided a range of other complementary services in order to create an optimum privacy and security solution for its customers. The complementary services may include, but are not limited to, the following:

1. Cookie crushing

A service that allows customers to periodically delete cookie files of their choice from their computer systems.

2. Anonymous web surfing and emailing

Complimentary anonymous webs surfing and anonymous emailing services allow customers to conduct virtually all of their online activities anonymously.

3. Digital/Electronic wallet software

In one embodiment, the invention also provides customers a digital wallet that features online form filling capability. The wallet may also serve as a means of secure communication between the OPS server and the customer's computer during a payment transaction between the OPS 33 and the customer 11. These capabilities, online form filling and instantaneous interaction between the OPS server and users will then consequently enhance customer's online shopping experience.

4. Anonymous Pick-Up Service

To complete the anonymous shopping service of the present invention, the OPS 33 may align itself with one or several major logistics companies. The logistics company/companies may facilitate anonymous pickup services where customers can have their physical goods purchased with OPS 33 Purchasing Cards sent to the logistics company's outlets and pick up the goods with a unique and anonymous identifier provided by the OPS 33.

5. Third Party Nominees

The system may include a form filling function determined by instructions of the customer 11 which may include the use of a nominee or third party.

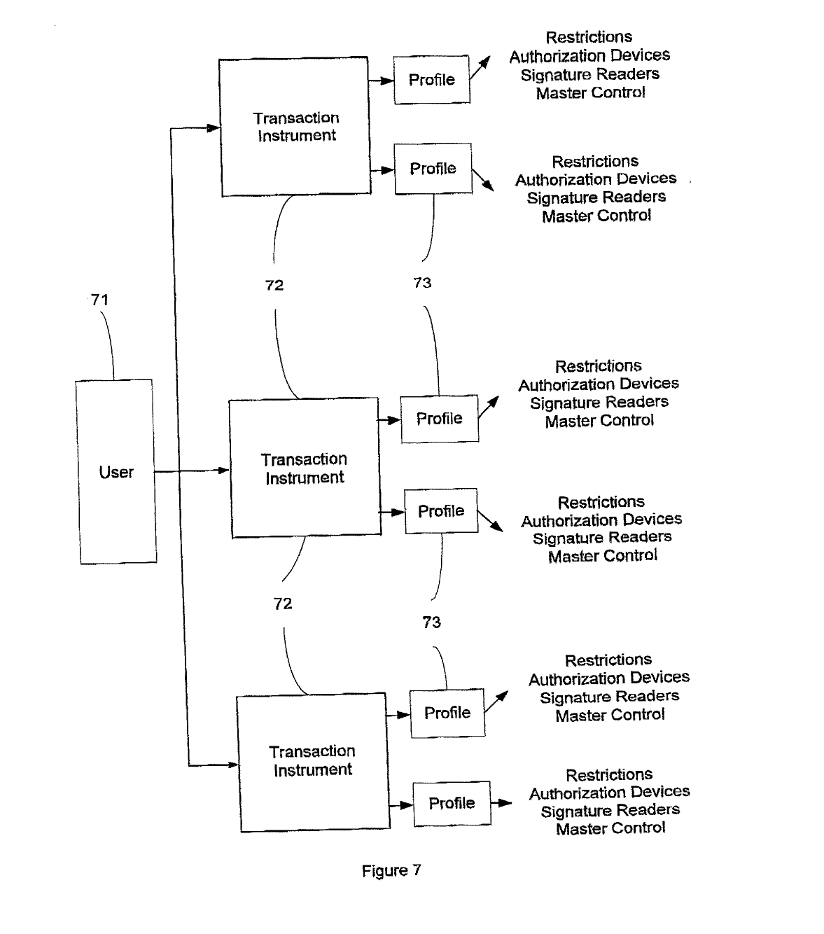

Referring to FIG. 7, another embodiment of the invention creates a payment system where a user 71 (a customer 11 or OPS 33) may create and vary the authorization profile for payment transactions conducted using a transaction instrument 72. A transaction instrument 72 may include a credit card, debit card, prepaid card and or some other form of payment system. The customer 11 (or user 71) or transaction instrument-issuing financial institution may then modify the authorization profile at anytime to update, change and/or modify various restrictions on the transaction instrument 72. The combination of one or several restrictions creates a “profile” 73, specific to each transaction instrument holder, listing the user's 71 selected restrictions. Changes to the profile 73 may then be enabled, disabled and/or modified at anytime by the user via some form of communication system, such as but not limited to: the Internet, WAP technology, bank machine or telephone call. Additionally, a funds transfer profile may be set to access a sequentially predetermined source of finds if the primary account becomes depleted.

Preset profiles may be set by the transaction instrument-issuing financial institution for the convenience of their clients. These preset profiles could contain a combination of, or singularly, various restrictions grouped together so as to be easily invoked by the user by entering in a security code/Personal Identification Number (PIN) unique to each profile. Enabling a different profile could invoke a different set of restrictions appropriate for each transaction instrument holder, at that specific time.

Some restrictions that may be implemented to create a profile (in combination or singularly) by either the transaction instrument holder or the transaction instrument-issuing financial institutions include:

Account may be deactivated and reactivated at any time;

Cash advances may be allowed or disallowed;

Limits put on the time of day the credit instrument is available (e.g., not after 3 am and not before 9 am local time for the user);

Limits on both or either maximum and minimum transaction amounts (e.g., the user may set his or her transaction instrument to accept only charges ranging between $20 and $140);

Limits on the currencies available for the transaction(s) (e.g., Rubles disallowed, only US & Canadian currencies allowed);

Geographical limits on where the transaction instrument may be used, (e.g., within the transaction instrument holder's city, province/state, country, zip code, area code either singularly or in any combination);

Which merchants the transaction instrument may work for (e.g., disallow: adult shops, online merchants/mail order/phone order transactions);

Excluding specific items allowed to be purchased, such as computer equipment, stereos, jewellery, etc.;

Transaction instrument holder must be present for the transaction to be conducted via some form of proximity device (e.g., the transaction instrument holder must be in the same city for the transaction to be conducted);

Limits on how far away the transaction instrument holder may be from the transaction instrument to conduct a purchase (e.g., an out of range/proximity restriction could be enacted if the transaction instrument is used more than 100 feet from the transaction instrument holder). The distance could be measured using either a global positioning system (GPS) enabled device or an electronic code syncing device such as: personal digital assistant (PDA) (or a device similar to a Palm Pilot (TM)), a Blackberry (TM) device, a cellular phone, a watch with an electronic chip, or a wireless application protocol (WAP) device, or some other device able to measure distance between two items; and

Transaction instrument holder could register their “self control issues”, for example restricting:

Alcoholic beverages;

Fast food outlets; and

Impulsive shopping

(e.g., no more than 1 purchase per hour/day).

The payment system, in one embodiment, uses physical cards that can be authorized for use in advance or dynamically.

In one embodiment, several criteria could be set in each profile 73 allowing modification of the profiles' authorization criteria. Verification of the authenticity of the transaction instrument holder may include either a combination of, or singularly, the following items:

Personal Identification Number (PIN);

Security code;

Digital signatures;

Written signatures;

IP address;

Domain Address;

Retinal scanners;

Voice recognition;

Finger print readers;

Weight scales;

Handprint; and

Footprint.

In another embodiment, Signature Readers may be used to restrict the transaction instrument holder from using the transaction instrument while intoxicated through the use of intoxication criteria or intoxication identifier technologies.

As well, Signature Readers could also be used to allow pre-registered users to access the account if their signature matches one on record. For example, a child of a profiled transaction instrument holder could be allowed to conduct transactions using their parent's transaction device.

The transaction instrument may also incorporate a number of other features, which may be selected either in combination or singularly. These features may include:

Transaction instrument may have the option of not having the transaction instrument holder's name, account number, or expiry date visibly imprinted;

If an attempt to access the account, contrary to the restrictions established by the user, occurs at a transactional location then the transaction instrument may be:

Confiscated/ not returned to the user;

A telephone call and or e-mail message could be initiated to the transaction instrument holder notifying them of the violation;

The police could be called if an emergency code is not then entered; and/or

A signal may be sent to police or interested parties identifying the location of the transaction instrument holder;

Entering a Personal Identification Number (PIN) at a bank machine of some sort may reinstate the user's default profile;

Transaction instrument holder must be present at the point of sale to conduct transaction (derived via an electronic device able to determine proximity);

An emergency/panic code Personal Identification Number (PIN) may be entered at a bank machine notifying police the user was being robbed or was in immediate danger; and/or

Each transaction may be reported to each user or just the primary account holder via some form of communication system such as email.

Master control settings may be enabled allowing only authorized transaction instrument holders to modify the restrictions for themselves or a group of users. For example, a parent may control all transaction instruments held by his or her family. Changing the restrictions on the transaction instrument(s) may only be conducted by the transaction instrument holder authorized to make changes. For example, the following criteria, among other criteria, may be included:

Permissions may only be changed from the transaction instrument holder's home phone number, within a specific area code, time period, by identifying themselves using a Personal Identification Number (PIN) or any combination of the above.

Additionally, the user may over-ride transaction denial responses, enacted by the transaction instrument's issuing financial institution (referred to as fraudulent use “red flags”) by identifying themselves via a Personal Identification Number (PIN).

The payment service in accordance with the present invention may operate differently in different embodiments. In one embodiment, users, other than the primary transaction instrument holder, may access funds from the primary transaction instrument holder's account via an additional transaction instrument. That is, a single account may have several transaction instruments issued to it.

In another embodiment, users, other than the primary transaction instrument holder, may access funds from a separate account via an additional transaction instrument. The additional transaction instrument may have restrictions placed on it by the primary transaction instrument holder.

Payment may also be provided to the other user at scheduled times/dates (e.g., used to payout allowances to children).

Additionally, different restrictive profiles may be set up for a group of transaction instrument holders, such as a family, with each transaction instrument registered to access a joint account. For example: one parent with a large credit limit need set at $5000, another parent with a smaller credit limit need set at $500, and their children and or domestic workers may be issued a transaction instrument with a credit limit need set at $40. Additionally any number of restrictions could be placed on the child's transaction instrument (e.g., limiting where the children may use the transaction instrument).

In another embodiment, funds are “drawn down” using a funds transfer profile enabled by the user. This profile may be set to access a sequentially predetermined source of funds if the primary account becomes depleted. For example, the sequential source of funds, among other sources, may include: the transaction holder's personal line of credit, savings account, checking account, and/or registered retirement savings plans (RRSPs).

one embodiment, transaction instrument statements may be accessed online in real time. If an anonymous transaction number is used this is where the transaction instrument holder goes to look up the transaction instrument number.

One objective of the payment system is to limit the risk of fraud or credit theft for both the transaction instrument holder and or the transaction instrument-issuing financial institution. The payment system allows the user to gain further control over their credit instrument by allowing them to modify a combination of restrictions at anytime. For example, transaction instrument holders who do not regularly travel outside their city, nor purchase high-end electronic equipment regularly, can enable restricting out of town charges, as well as restricting purchases on the credit instrument to restaurants only through the payment system. The user could then remove the restriction(s) for a specified period of time and or indefinitely.

The following examples are not intended to be limiting in anyway and serve only as some of the many possible scenarios that may exist within the scope of the invention. The transaction instrument holder may select a merchant where a transaction had to occur before a credit limit restriction on the transaction instrument could be automatically raised. For example, the user may set his profile requiring that his transaction instrument be used for one transaction at a particular restaurant before the credit limit could be automatically raised to a preset higher limit of $500.

Additionally, the transaction instrument holder may set a transaction range that had to occur before the restrictions on the transaction instrument could be automatically changed. For example, the user set up his profile requiring that his transaction instrument be used for one transaction of $20-$25 before the maximum credit limit could be automatically raised to his preset higher limit.

An example of one preset profile is: restricting out of town purchases, restricting the transaction instrument's transaction amount limit to $200, restricting purchases between the hours of 12 am and 11:30 am, restricting any purchases from adult shops, computer shops, and orjewellery stores. Another possible preset profile may restrict the number of purchases conducted within a two-hour period, while not restricting the transaction amount limit. In either case each preset profile may be enabled, disabled and or modified at anytime by entering a PIN unique to that profile via some form of communication system.

In another example, a parent may assign a transaction instrument to their child to be used for purchasing clothing. In this scenario, the parent may invoke a profile (with a set of restrictions) to be applied to the transaction instrument by entering in special PIN. The profile may include a credit limit of $200, an individual transaction limit of $60, restricting the amount of time the transaction instrument is enabled, as well as restrict the transaction instrument from being used to purchase goods other than clothing. Once the child has completed their purchases the transaction instrument may then be returned to its disabled state by entering a default PIN.

Another embodiment of the invention is a total online privacy service provider, aiming to promote independent/individual Internet users' awareness of online privacy and provide them with tools to control their own online privacy and security exposure. This embodiment of the invention allows customers to maintain anonymity for online purchases. By using their own credit cards issued to them rather than some form of cyber cash, and by virtue of the confidentiality and the credit card safety of the online payment service, this is accomplished in a simple, user friendly system. Another embodiment of the invention allows its customer to make online purchases without any record of the purchase being traceable to the user. Further, it allows the purchaser to deal with any web merchant; it does not require the merchant to subscribe to the service. As well, it provides the customers with control over restrictions placed on their transaction instruments.

An OPS 33 transaction process and network may each be implemented by any hardware, software or a combination of hardware and software having the above described functions. The software code, either in its entirety or a part thereof, may be stored in a computer readable memory. Furthermore, a computer data signal representing the software code which may be embedded in a carrier wave may be transmitted via a communication network. Such a computer readable memory and a computer data signal are also within the scope of the present invention, as well as the hardware, software and the combination thereof.

While specific embodiments of the present invention have been described, various modifications and substitutions may be made to such embodiments. Such modifications and substitutions are within the scope of the present invention, and are intended to be covered by the following claims.

What is claimed is:

1. A method of effecting an anonymous payment comprising the steps of:
receiving an order for a purchasing card from a customer; and
assigning a purchasing card to the customer, the purchasing card being usable to purchase goods and services.

2. A method as claimed in claim 1, further comprising the step of securing payment from the customer for the order.

3. A method as claimed in claim 1, said purchasing card comprises predetermined spending limitations.

4. A method as claimed in claim 2, wherein said spending limitations may be set by the customer.

5. A method as claimed in claim 2, wherein said spending limitations may be modified by the customer.

6. A method as claimed in claim 1, further comprising steps of financial reconciliation of the purchasing card.

7. A method of effecting online payments comprising the steps of:
an end user obtaining a purchasing card; and
an end user shopping online using the purchasing card information to effect payment.

8. A method as claimed in claim 7, wherein said step of obtaining comprises the steps of:
the end user ordering the use of the purchasing card from an online payment service; and
the end user receiving the purchasing card information.

9. A method as claimed in claim 8, wherein said step of ordering is performed via telephone.

10. A method as claimed in claim 8, wherein said step of ordering is performed in a financial institution.

11. A method as claimed in claim 8, wherein said step of receiving is performed via electronic mail.

12. A method as claimed in claim 7, wherein said step of receiving is performed on a website.

13. A method as claimed in claim 7 wherein said step of receiving comprises steps of:
obtaining information from an electronic mail; and
using the information obtained in the electronic mail to obtain the purchasing card information from a website.

14. A method as claimed in claim 7, wherein said step of effecting payment comprises the end user using the purchasing card information in place of requests for credit card information.

15. A system for effecting online payments comprising:
a customer network;
a merchant network, the customer network in communication with the merchant network; and
an online payment service network in communication with the customer network for creating a credit identity for a customer.

16. A system as claimed in claim 15, further comprising:
a customer financial institution, the customer network in communication with the customer financial institution;
an online payment service financial institution, the online payment service network in communication with the online payment service financial institution; and
a first certifying authority in communication with the customer financial institution and the online payment service financial institution.

17. A system as claimed in claim 16, wherein the first certifying authority certifies the identity of the customer to the online payment service financial institution.

18. A system as claimed in claim 15, further comprising:
a merchant financial institution, the merchant network in communication with the merchant financial institution;
a second certifying authority in communication with the merchant financial institution and an online payment service financial institution.

19. A system as claimed in claim 18, wherein the second certifying authority certifies the identity of the online payment service to the merchant financial institution.

20. A system as claimed in claim 15, wherein a customer is able to obtain a purchasing card from the online payment service network and use said purchasing card to effect payment for items on the merchant network.

21. An online payment service for effecting online payments comprising:
a receiver for receiving an order for a purchasing card from a customer;
processing means for securing payment from the customer for the order; and
a notifier for notifying the customer of purchase card information.

22. A method of effecting an anonymous payment comprising the steps of:
obtaining a transaction instrument;
assigning restrictions to the transaction instrument; and
a customer using the transaction instrument to make purchases.

23. Computer-readable media for storing instructions or statements for use in the execution in a computer of a method for effecting an online payment, the method comprising steps of:
receiving an order for a purchasing card from a customer; and
assigning a purchasing card to the customer, the purchasing card being usable to purchase items online.

24. A computer program product for use in the execution in a computer for effecting an online payment, the method comprising steps of:
receiving an order for a purchasing card from a customer; and
assigning a purchasing card to the customer, the purchasing card being usable to purchase items online.

25. A computer data signal embodied in a carrier wave and representing sequences of instructions which, when executed by a processor, cause the processor to effect an online payment, the sequences of instructions comprising the steps of:
receiving an order for a purchasing card from a customer; and
assigning a purchasing card to the customer, the purchasing card being usable to purchase items online.
